(19) United States
(12) Patent Application Publication
(10) Pub. No.: US 2011/0102873 A1
(43) Pub. Date: May 5, 2011

(54) OPTICAL SCANNING DEVICE AND IMAGE FORMING APPARATUS PROVIDED WITH OPTICAL SCANNING DEVICE

(75) Inventor: Takasumi Wada, Osaka-Shi (JP)

(73) Assignee: SHARP KABUSHIKI KAISHA, Osaka (JP)

(21) Appl. No.: 12/940,242

(22) Filed: Nov. 5, 2010

(30) Foreign Application Priority Data
Nov. 5, 2009 (JP) 2009-254137

(51) Int. Cl. G02B 26/08

(52) U.S. Cl. 359/204.1

(57) ABSTRACT

An optical output level of laser diodes is detected by a photodiode for each of the laser diodes, and this photodiode detection output is used in feedback control of the laser diodes, thereby achieving stabilization of the optical output levels of the laser diodes. Furthermore, feedback control gain and laser diode bias are stored in an EEPROM (nonvolatile memory), and the feedback control is carried out according to arithmetic processing by an integrated circuit using the gain and bias in the EEPROM such that malfunctions of the optical scanning device can be addressed by rewriting the gain and bias in the EEPROM.

### BACKGROUND OF THE INVENTION

This application claims priority under 35 U.S.C. §119(a) on Patent Application No. 2009-254137 filed in Japan on Nov. 5, 2009, the entire contents of which are herein incorporated by reference.

The present invention relates to optical scanning devices that scan a photoreceptor surface in an image forming apparatus using optical beams of a semiconductor laser and to image forming apparatuses provided with these optical scanning devices.

This type of optical scanning device is applied in electrophotographic image forming apparatuses. In image forming apparatuses of this format, an electrostatic latent image is formed on a photoreceptor surface, then the electrostatic latent image is developed using toner to form a toner image on the photoreceptor surface, the toner image is transferred from the photoreceptor surface to a recording paper, then the recording paper is subjected to heat and pressure to fix the toner image onto the recording paper.

An optical scanning device is used to form the electrostatic latent image on the photoreceptor surface. With these devices, an intensity of an optical beam outputted from the semiconductor laser is modulated in response to image data, then the modulated optical beam of the semiconductor laser is irradiated onto a polygon mirror, and the optical beam is reflected by the polygon mirror. Then, by rotating the polygon mirror, the optical beam is repetitively deflected in a scanning direction due to the rotation of the polygon mirror, and moreover deflection is performed using an f-theta lens so that the optical beam achieves a uniform velocity on the photoreceptor surface, and the optical beam scans the photoreceptor surface, thereby forming the electrostatic latent image on the photoreceptor surface.

Here, the semiconductor laser (laser diode) has large unevenness in its output level characteristics with respect to its drive current. FIG. 9 is a graph showing characteristics of three laser diodes. As is evident from this graph, the output level characteristic with respect to the drive current is different for each laser diode, and there is unevenness in the drive current at oscillation commencement and in the slant of output level characteristics. For this reason, a light-receiving element is provided for each laser diode to detect the light output level of the laser diode, and feedback control is performed on the drive current of the laser diode based on the detection output of the light-receiving element. Furthermore, it is necessary to carry out adjustments for gain in the feedback control and bias current of the laser diodes.

For example, a photodiode 202 is provided in a vicinity of a laser diode 201 as shown in FIG. 10, and the light output level of the laser diode 201 is detected by the photodiode 202, then the detection output of the photodiode 202 is accumulated in a capacitor 203, and a terminal voltage of the capacitor 203 is applied to a comparator 204. The comparator 204 compares the terminal voltage of the capacitor 203 with a prescribed voltage that indicates a prescribed light output level, and this comparison result is outputted to an analog control portion 205. The analog control portion 205 increases/decreases a drive current IF of the laser diode 201 based on this comparison result. In this way, the output level of the laser diode 201 undergoes feedback control while it is on.

A binary signal of image data is applied through a receiver 207 to a switching element 206, which switches on/off in response to the binary signal of image data. In this way, a drive current IF route constituted by the laser diode 201 to the analog control portion 205, then to the switching element 206, is turned on/off, and the laser diode 201 is turned on and off in response to the binary signal of image data.

Furthermore, a sensitivity adjustment volume 208 is connected in parallel to the capacitor 203, and the terminal voltage of the capacitor 203 is adjusted by the sensitivity adjustment volume 208, thereby adjusting feedback control gain.

Further still, a bias adjustment volume 209 is serially connected to a cathode of the laser diode 201 via the analog control portion 205, and the bias voltage of the laser diode 201 is adjusted by the bias adjustment volume 209, and in this way a response characteristic of the laser diode 201 is adjusted.

FIGS. 11(a) to 11(c) show timing charts indicating operations in the conventional circuit shown in FIG. 10. In FIG. 11, a period from T₂ to T₃ is a main scanning period. A period from T₀ to T₁ is set prior to this main scanning period, and as shown in FIG. 11(a), a light amount correction on signal is applied to the switching element 206 via the receiver 207 in this T₀ to T₁ period such that the switching element 206 turns on and the drive current IF is provided to the laser diode 201, then the laser diode 201 emits light, and the detection output of the photodiode 202 is accumulated in the capacitor 203. Then, the terminal voltage of the capacitor 203 is fed back, thereby setting a sample hold value of the capacitor 203 as shown in FIG. 11(c) while controlling the drive current IF of the light source 201.

Following this, during the main scanning period from T₂ to T₃, the comparator 204 compares the terminal voltage of the capacitor 203 with the prescribed voltage, then this comparison result is outputted to the analog control portion 205. The analog control portion 205 controls the drive current IF of the laser diode 201 based on this comparison result such that the output level of the laser diode 201 is controlled to be substantially uniform while on. Then, the switching element 206 switches on/off in response to the binary signal of image data as shown in FIG. 11(b), thereby turning the laser diode 201 on and off.

These operations of T₀ to T₃ are repeated for each main scan so that writing is carried out by the optical beam of the laser diode 201.

In this regard, ordinarily a beam spot on the photoreceptor surface is restricted to approximately 50 microns or less, and a scanning position thereof also requires a precision of approximately several microns. Furthermore, although the optical intensity of the beam spot corresponds to the final print density, in a case of a light halftone image for example, a variation in optical intensity of several percent will appear as uneven print density, and moreover will appear as color unevenness if this is a color image. Accordingly, extremely high optical characteristics are required in optical scanning devices. In particular, advances have occurred in recent years offering higher speeds, greater use of color, and greater fineness, and multibeam scanning is employed in which scanning by multiple optical beams is carried out simultaneously, and it is common for a format to be employed in which a scanned image of each color is superimposed to achieve greater use of color, so that demands on optical scanning units are becoming increasingly high.

However, with the conventional circuit of FIG. 10, since the terminal voltage of the capacitor 203 is approximately uniform during the main scanning period of T₂ to T₃, the output level of the laser diode 201 is also uniform, and in a case where partial light amount attenuation occurs from between the laser diode 201 to the photoreceptor, density unevenness is produced in the electrostatic latent image on the photoreceptor surface, and this becomes unevenness in the print density.

For this reason, in JP 2003-320703A (patent document 1), a region to be scanned on the photoreceptor by the optical beams is divided into sections, and a light amount is set for each divided section, then the section being scanned by the optical beams is detected and the light amounts of the optical beams are adjusted and controlled to the light amount of the section that has been detected.

In this case, the light amount of the optical beams can be adjusted and controlled to the light amount of that section for any section in the scanning range, and no density unevenness occurs in the electrostatic latent image on the photoreceptor surface.

Furthermore, in JP 2007-71918A (patent document 2), a scanning position displacement of each optical beam is measured before integration of the optical scanning device, and these scanning position displacements are stored, then after the integration of the optical scanning device, each of the scanning position displacements is used as a correction value.

In this case, the precision of the scanning position of each of the optical beams can be improved.

However, even though adjustment and control can be performed on the light amounts of the optical beams in patent document 1, and even though the precision of the scanning position can be improved for each of the optical beams in patent document 2, there is no technical contrivance in relation to adjusting feedback control gain and laser diode 201 bias for the feedback control using the combination of the laser diode 201 and the photodiode 202 shown in FIG. 10.

In the conventional circuit of FIG. 10, feedback control gain is adjusted by the sensitivity adjustment volume 208 and the laser diode 201 bias is adjusted by the bias adjustment volume 209, but after the optical scanning device is mounted in the image forming apparatus, such adjustments cannot be carried out if the optical scanning device malfunctions, and this is addressed by replacing the optical scanning device. This is because optical scanning device adjustments require using specialized tools in a cleanroom. Moreover, electrically sensitive semiconductor lasers and motors for polygon mirrors that rotate at high speeds are mounted in optical scanning devices, and these very frequently malfunction. For this reason, improvements in the maintainability of optical scanning devices are desired.

Accordingly, the present invention has been devised in consideration of the aforementioned conventional problems, and it is an object thereof to provide an optical scanning device and an image forming apparatus provided with this optical scanning device in which adjustments of feedback control gain and bias in a semiconductor laser can be carried out easily while the optical scanning device is mounted in the image forming apparatus.

### SUMMARY OF THE INVENTION

In order to address the above-described issues, an optical scanning device according to the present invention is provided with a semiconductor laser that outputs an optical beam, and a light-receiving element that detects an optical output level of the semiconductor laser, wherein detection output of the light-receiving element is used in feedback control of a drive current of the semiconductor laser, and a photoreceptor surface of an image forming apparatus is scanned by the optical beam of the semiconductor laser, and is further provided with a nonvolatile memory in which gain of the feedback control is stored, an integrated circuit that calculates and obtains a drive current of the semiconductor laser based on the detection output of the light-receiving element and the feedback control gain in the nonvolatile memory, and provides the obtained drive current to the semiconductor laser, and a substrate on which the integrated circuit and the nonvolatile memory are mounted together.

With the optical scanning device according to the present invention, an integrated circuit calculates and obtains a drive current of the semiconductor laser based on the detection output of the light-receiving element and the feedback control gain in the nonvolatile memory, and provides the obtained drive current to the semiconductor laser. For this reason, if feedback control gain necessary for the arithmetic processing is set and stored in a nonvolatile memory, the feedback control of the semiconductor laser can be carried out stably.

Furthermore, the integrated circuit and the nonvolatile memory are mounted on a common substrate, and therefore a correspondence of the integrated circuit can be maintained with the feedback control gain in the nonvolatile memory.

Further still, nonvolatile memories are mounted and used separately without using an inbuilt memory of the integrated circuit, and therefore it is possible to access the nonvolatile memory from an external source and rewrite the feedback control gain in the nonvolatile memory. Adjustment and repair of the optical scanning device are possible by rewriting the gain, thereby reducing the frequency of replacing malfunctioned optical scanning devices as conventionally, and improving maintenance qualities.

Supposing a case where feedback control gain is stored in an inbuilt memory of the integrated circuit, then external access to the memory of the integrated circuit and rewriting of gain are difficult, and adjustment and repairs of the optical scanning device by rewriting the gain cannot be achieved.

Furthermore, in this configuration, the nonvolatile memory may store a bias current value of the semiconductor laser, and the integrated circuit may read out the bias current value of the semiconductor laser from the nonvolatile memory and provide a bias current of this value to the semiconductor laser.

In this case, the bias current value of semiconductor laser is stored in the nonvolatile memory, and the bias current value of the semiconductor laser is read out from the nonvolatile memory and set by the integrated circuit, and therefore the response characteristics of the semiconductor laser can be controlled.

Further still, in this configuration, the nonvolatile memory may store a variation pattern of optical beam intensities in a single scan period of the photoreceptor surface by the optical beam of the semiconductor laser, and the integrated circuit may read out from the nonvolatile memory the variation pattern of optical beam intensities in a single scan period of the photoreceptor surface and control a drive current of the semiconductor laser so that the variation pattern that has been read out is reproduced in each single scan of the photoreceptor surface.

In this case, the variation pattern of optical beam intensities in a single scanning period on the photoreceptor surface by the optical beam of the semiconductor laser is stored in the nonvolatile memory, and the drive current of the semiconductor laser is controlled by the integrated circuit so that the variation pattern of optical beam intensities is reproduced in the single scanning period of the photoreceptor surface, and therefore shading correction can be carried out.

Furthermore, in this configuration, the nonvolatile memory may carry out reading and writing according to access from an image forming apparatus or an external terminal.

In this case, the nonvolatile memory carries out reading and writing according to access from an image forming apparatus or an external terminal. Specifically, gain or the like in the nonvolatile memory can be rewritten from the image forming apparatus or an external terminal by using I2C or Microwire or the like, which are commonly known transmission formats to memories.

Further still, in this configuration, the nonvolatile memory may be removable from the substrate.

In this case, the nonvolatile memory is removable from the substrate, and therefore, specifically, a USB memory or a memory card is applied as the nonvolatile memory, and the nonvolatile memory is removed such that gain or the like in the nonvolatile memory can be rewritten.

Furthermore, in this configuration, the nonvolatile memory may store information relating to the optical scanning device.

In this case, the nonvolatile memory stores information relating to the optical scanning device, and therefore, for example, stores a model number and lot number of the semiconductor laser, substrate information, a ROM area of the integrated circuit, information of the nonvolatile memory itself, and an ID. This information is effective in maintenance of the optical scanning device.

Furthermore, another optical scanning device according to the present invention is provided with a semiconductor laser that outputs an optical beam, wherein a photoreceptor surface of an image forming apparatus is scanned by the optical beam of the semiconductor laser, and is further provided with a nonvolatile memory that stores information relating to the optical scanning device, an integrated circuit that controls the semiconductor laser based on the information in the nonvolatile memory, and a substrate on which the integrated circuit and the nonvolatile memory are mounted together, wherein the nonvolatile memory is capable of reading and writing according to access from an external source.

With another optical scanning device according to the present invention, a nonvolatile memory that stores information relating to the optical scanning device, and an integrated circuit that controls the semiconductor laser based on the information in the nonvolatile memory are mounted on a common substrate, and reading and rewriting of the nonvolatile memory can be carried out according to access from an external source. As described earlier, information relating to the optical scanning device in the nonvolatile memory includes a model number and lot number of the semiconductor laser, substrate information, a ROM area of the integrated circuit, information of the nonvolatile memory itself, and an ID, and is used in maintenance of the optical scanning device. For this reason, when the optical scanning device malfunctions, the information in the nonvolatile memory is read out, and the information that is read out can be used in repairing the optical scanning device.

Supposing a case where feedback control gain is stored in an inbuilt memory of the integrated circuit, then external access to the memory of the integrated circuit and rewriting of gain are difficult.

Furthermore, an image forming apparatus according to the present invention is provided with an optical scanning device according to the present invention described above.

Since an image forming apparatus according to the present invention is provided with an optical scanning device according to the present invention described above, an equivalent effect is achieved.

### BRIEF DESCRIPTION OF THE DRAWINGS

FIG. 1 is a cross-sectional view showing an image forming apparatus in which one embodiment of an optical scanning device according to the present invention has been applied.

FIG. 2 is a perspective view showing an optical scanning device according to the present embodiment.

FIG. 3 is constituted by FIG. 3(a), and FIG. 3(b), these being a top view and a cross-sectional view showing the optical scanning device according to the present embodiment.

FIG. 4 is a block diagram showing components such as laser diodes, integrated circuits, and an EEPROM mounted on a substrate in an optical scanning device according to the present embodiment, and components such as a main control portion and an operation panel in an image forming apparatus.

FIG. 5 is a block diagram showing an overall circuit configuration on the substrate of the optical scanning device according to the present embodiment.

FIG. 6 is a block diagram showing a select view of one combination of the laser diode and the photodiode, the integrated circuit, the EEPROM on a substrate of the optical scanning device according to the present embodiment, and the main control portion of the image forming apparatus.

FIG. 7 is constituted by FIGS. 7(a) to 7(d) and shows timing charts indicating operations in the circuit shown in FIG. 6.

FIG. 8 is a block diagram showing a modified example of the optical scanning device.

FIG. 9 is a graph showing characteristics of three laser diodes.

FIG. 10 is a block diagram showing a circuit configuration of a conventional optical scanning device.

FIG. 11 shows timing charts indicating operations in the conventional circuit shown in FIG. 10.

### REFERENCE SIGNS LIST

1 optical scanning device
2 development apparatus
3 photosensitive drum
4 cleaner device
5 charging unit
8 intermediate transfer belt apparatus
10 paper feed tray
11 secondary transfer apparatus
12 fixing apparatus
41 image reading device
42 original transport device
44 platen glass
45 first scanning unit
46 second scanning unit
47 imaging lens
48 CCD (charge coupled device)
51 light source
52 first reflector mirror
53 second reflector mirror
54 third reflector mirror
65 original reading glass
A image forming apparatus

### DESCRIPTION OF EMBODIMENTS

Hereinafter, embodiments of the present invention are described in detail with reference to the accompanying drawings.

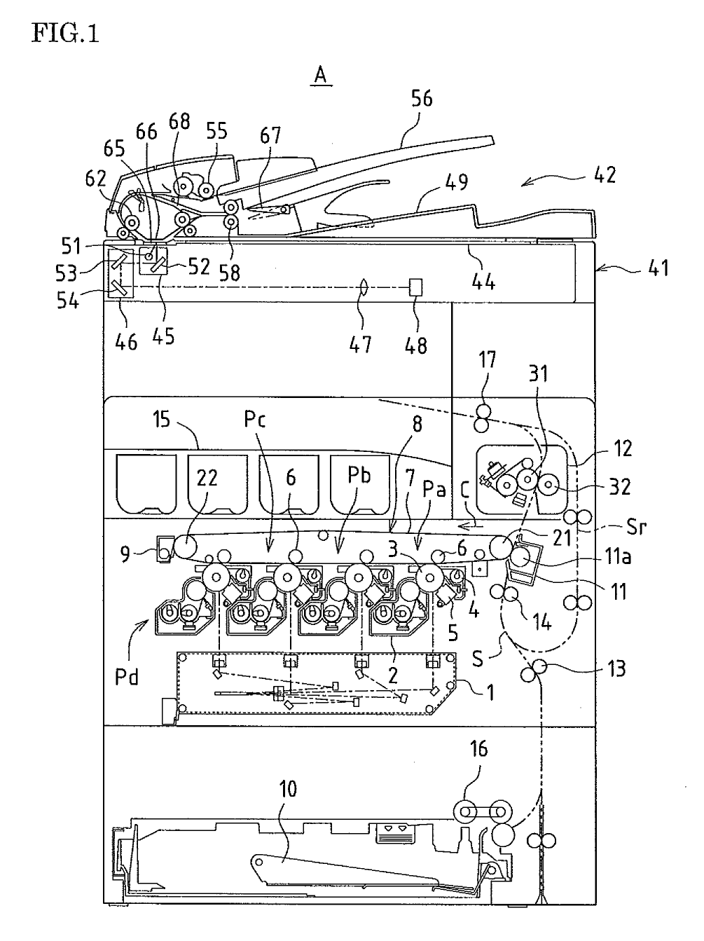

FIG. 1 is a cross-sectional view showing an image forming apparatus in which one embodiment of an optical scanning device according to the present invention has been applied. An image forming apparatus A is a so called multifunction machine having functions such as a scanning function, a copying function, a printing function, and a fax machine function, and an image of an original that has been read by an image reading device 41 is transmitted externally (corresponding to the scanning function), then the image of this original that has been read, or an image that has been received from outside is recorded and formed on a recording paper in color or monochrome (corresponding to the copying function, printing function, and fax machine function).

In order to print an image on a recording paper, the image forming apparatus A is provided with components such as an optical scanning device 1, development apparatuses 2, photosensitive drums 3, charging units 5, cleaner apparatuses 4, an intermediate transfer belt apparatus 8, a fixing apparatus 12, a paper transport path S, a paper feed tray 10, and a paper discharge tray 15.

The image data handled in the image forming apparatus A corresponds to color images using each of the colors black (K), cyan (C), magenta (M), and yellow (Y), or corresponds to a monochrome image using a single color (for example, black). Thus, four sets each of the development apparatus 2, the photosensitive drum 3, the charging unit 5, and the cleaner device 4 are provided to form four toner images corresponding to the four colors, with these being associated with black, cyan, magenta, and yellow respectively, thereby constituting four image stations Pa, Pb, Pc, and Pd.

Each of the photosensitive drums 3 is provided with a photosensitive optical layer on its surface. Each of the charging units 5 is a charging means for uniformly charging the surface of its respective photosensitive drum 3 to a predetermined electric potential and in addition to contact types such as roller and brush charging units, charger type charging units are also used.

The optical scanning device 1 is a laser scanning unit (LSU) provided with a laser diode and reflector mirrors, and exposes the surfaces of the charged photosensitive drums 3 in response to image data such that an electrostatic latent image is formed on each of the surfaces corresponding to the image data.

Each of the development apparatuses 2 develops the electrostatic latent images formed on the surface of its respective photosensitive drum 3 using (K, C, M, or V toner, thereby forming toner images on the surfaces of the photosensitive drums 3. Each of the cleaner devices 4 removes and collects toner that is residual on the surface of its respective photosensitive drum 3 after development and image transfer.

The intermediate transfer belt apparatus 8 is positioned above the photosensitive drums 3, and is provided with an intermediate transfer belt 7, an intermediate transfer belt drive roller 21, an idler roller 22, four intermediate transfer rollers 6, and an intermediate transfer belt cleaning device 9.

The intermediate transfer belt 7 is a film having a thickness of approximately 100 μm to 150 μm formed in an endless belt shape. The intermediate transfer belt 7 spans in a tensioned state and is supported by the intermediate transfer belt drive roller 21, each of the intermediate transfer rollers 6, and the idler roller 22. The intermediate transfer belt 7 is caused to circle there-around in a direction of an arrow C.

Each of the intermediate transfer rollers 6 is rotatably supported near the intermediate transfer belt 7, and presses against its respective photosensitive drum 3 through the intermediate transfer belt 7.

The toner image on the surface of each of the photosensitive drums 3 is superimposed and transferred in order onto the intermediate transfer belt 7, thereby forming a color toner image (a toner image having each of these colors) on the intermediate transfer belt 7. Transfer of the toner image from each of the photosensitive drums 3 to the intermediate transfer belt 7 is carried out by each of the intermediate transfer rollers 6 that presses against the rear surface of the intermediate transfer belt 7. Each of the intermediate transfer rollers 6 is a roller based on a metal shaft (for example stainless steel) having a diameter of 8 to 10 mm, and the surface thereof is covered by a conductive elastic material (for example, EPDM or urethane foam or the like). A high voltage transfer bias (a high voltage that has opposite polarity (+) to the charge polarity (−) of the toner) is applied to each of the intermediate transfer rollers 6 to achieve transfer of the toner images, and the high voltage is applied uniformly to the recording paper due to the conductivity of the elastic material.

Thus, the toner image on the surface of each of the photosensitive drums 3 is layered onto the intermediate transfer belt 7 to become a color toner image indicated by the image data. This color toner image is transported together with the intermediate transfer belt 7 then transferred onto a recording paper at a nip region between the intermediate transfer belt 7 and a transfer roller 11a of a secondary transfer apparatus 11.

A voltage (a high voltage that has an opposite polarity (+) to the charge polarity (−) of the toner) is applied to the transfer roller 11a of the secondary transfer apparatus 11 in order for the color toner image on the intermediate transfer belt 7 to be transferred to the recording paper. Furthermore, in order to steadily obtain the nip region between the intermediate transfer belt 7 and the transfer roller 11a of the secondary transfer apparatus 11, either the transfer roller 11a of the secondary transfer apparatus 11 or the intermediate transfer belt drive roller 21 is provided as a hard material (a metal or the like) and the other of these is provided as a soft material such as an elastic roller (elastic rubber roller or a foam resin roller or the like).

Furthermore, sometimes the toner images on the intermediate transfer belt 7 are not completely transferred onto the recording paper by the secondary transfer apparatus 11 and there is residual toner on the intermediate transfer belt 7, and this residual toner is a cause of mixed toner colors occurring at subsequent steps. For this reason, residual toner is removed and collected by the intermediate transfer belt cleaning device 9. In the intermediate transfer belt cleaning device 9, a cleaning blade is provided for example as a cleaning member that contacts the intermediate transfer belt 7 and removes residual toner, and the rear side of the intermediate transfer belt 7 is supported by the idler roller 22 at a position where the cleaning blade makes contact.

After the color toner image has been transferred at the nip region between the intermediate transfer belt 7 and the transfer roller 11a of the secondary transfer apparatus 11, the recording paper is transferred to the fixing apparatus 12. The fixing apparatus 12 is provided with a heating roller 31 and a pressure roller 32, and the recording paper is transported sandwiched between the heating roller 31 and the pressure roller 32.

The heating roller 31 is controlled based on detection output from an unshown temperature detector so as to reach a predetermined fixing temperature, and melts, mixes, and presses the color toner image that has been transferred onto the recording paper to thermally fix it to the recording paper by applying thermocompression to the recording paper along with the pressure roller 32.

On the other hand, the paper feed tray 10 is a tray for storing recording paper and is provided below the image forming apparatus A to supply the recording paper inside the tray.

An S-shaped paper transport path S is provided in the image forming apparatus A for sending the recording paper supplied from the paper feeding tray 10 to the paper discharge tray 15 via the secondary transfer apparatus 11 and the fixing apparatus 12. Arranged along the paper transport path S are components such as a paper pickup roller 16, paper registration rollers 14, the fixing apparatus 12, transport rollers 13, and discharge rollers 17.

The paper pickup roller 16 is provided at an end portion of the paper feeding tray 10 and is a draw-in roller that supplies recording papers sheet by sheet from the paper feeding tray 10 to the paper transport path S. The transport rollers 13 are small-size rollers for facilitating and assisting the transport of the recording papers, and a plurality of pairs of these are provided.

The paper registration rollers 14 provide well timed transport of the recording papers by temporarily stopping the recording paper that has been transported in and aligning the leading edge of the recording paper, then the rotations of each of the photosensitive drums 3 and the intermediate transfer belt 7 are matched so that the color toner image on the intermediate transfer belt 7 is transferred to the recording paper at the nip region between the intermediate transfer belt 7 and the transfer roller 11a of the secondary transfer apparatus 11.

For example, the paper registration rollers 14 transport the recording papers based on detection output of an unshown pre-registration detection switch so that the leading edge of the color toner image on the intermediate transfer belt 7 matches the leading edge of the image formation region of the recording paper at the nip region between the intermediate transfer belt 7 and the transfer roller 11a of the secondary transfer apparatus 11.

Further still, after the color toner image has been fixed by the fixing apparatus 12 and the recording paper has passed the fixing apparatus 12, the recording paper is discharged face down on the paper discharge tray 15 by the discharge rollers 17.

Furthermore, in a case of carrying out printing not only on the front side of the recording paper but on both sides, the discharge rollers 17 are caused to pause midway during transport of the recording paper by the discharge rollers 17 on the paper transport path S then to rotate in reverse such that front and back of recording paper are inverted by passing through an inversion route Sr, then the recording paper is guided to the registration rollers 14 and an image is recorded and fixed on the back side of the recording paper in a same manner as the front side of the recording paper, after which the recording paper is discharged to the paper discharge tray 15.

Next, description is given of the image reading device 41 and an original transport device 42. One inner side of the original transport device 42 is pivotably supported by a hinge (not shown in drawings) on one inner side of the image reading device 41, and a front area of the original transport device 42 can be opened and closed by being raised or lowered. When the original transport device 42 is open, a platen glass 44 of the image reading device 41 is uncovered, and an original can be placed on this platen glass 44.

The image reading device 41 is provided with components such as the platen glass 44, a first scanning unit 45, a second scanning unit 46, an imaging lens 47, and a CCD (charge coupled device) 48. While the first scanning unit 45, which is provided with a light source 51 and a first reflector mirror 52, moves in a sub scanning direction Y at a constant velocity V for a distance corresponding to the size of the original, the original on the platen glass 44 is exposed to light by the light source 51, and the reflected light thereof is reflected by the first reflector mirror 52 and guided to the second scanning unit 46, and in this way an image of the surface of the original is scanned in the sub scanning direction Y. While the second scanning unit 46, which is provided with second and third reflector mirrors 53 and 54, moves at a velocity V/2 following the first scanning unit 45, the reflected light from the original is reflected by the second and third reflector mirrors 53 and 54 and guided to the imaging lens 47. The imaging lens 47 focuses the reflected light from the original onto the CCD 48 such that an image of the surface of the original is formed on the CCD 48. The CCD 48 repetitively scans the image of the original in a main scanning direction and at each scan it outputs analog image signals of one main scanning line.

Furthermore, the image reading device 41 is also capable of reading not only stationary originals, but also capable of reading an image of the surface of an original that is being transported by the original transport device 42. In this case, the first scanning unit 45 is caused to move at a reading range below an original reading glass 65, and the second scanning unit 46 is positioned in response to the position of the first scanning unit 45, then, in this state, transport of the original commence by the original transport device 42.

In the original transport device 42, the pickup roller 55 touches the original at the top of the of the original tray 56 and rotates, thereby pulling out and transporting the original, then the leading edge of the original contacts the registration rollers 62, and after the leading edge of the original is aligned, the original passes between the original reading glass 65 and the reading guide panel 66, then the original is discharged by discharge rollers 58 to the discharge tray 49.

During the transport of this original, the surface of the original is illuminated through the original reading glass 65 by the light source 51 of the illumination portion 51 of the first scanning unit 45, and reflected light from the surface of the original is guided to the imaging lens 47 by the reflector mirrors of the first and second scanning units 45 and 46, then the reflected light from the surface of the original is focused on the CCD 48 by the imaging lens 47 such that an image of the surface of the original is formed on the CCD 48, and in this way an image of the surface of the original is read.

Furthermore, in a case of reading the back surface of the original, an intermediate tray 67 rotates on its shaft 67a as shown by the dotted line, then midway while the original is being discharged by the discharge rollers 58 to the discharge tray 49, the discharge rollers 58 are caused to stop, then the original is received on the intermediate tray 67 and the discharge rollers 58 are caused to rotate in reverse such that the original is guided to the registration rollers 62 via a reverse transport path 68, thereby reversing the front and back of the original, then an image of the back surface of the original is read in a same manner as the image of the front surface of the original, and the intermediate tray 67 returns to its original position as shown by the solid line, and the original is charged by the discharge rollers 58 to the discharge tray 49.

The image of the front surface of the original that has been read by the CCD 48 in this manner is outputted as analog image signals from the CCD 48, and these analog image signals undergo A/D conversion to digital image signals. Then, these digital image signals are transmitted to the optical scanning device 1 of the image forming apparatus A after undergoing various types of image processing, and the image is recorded onto a recording paper in the image forming apparatus A, then the recording paper is outputted as a reproduced original.

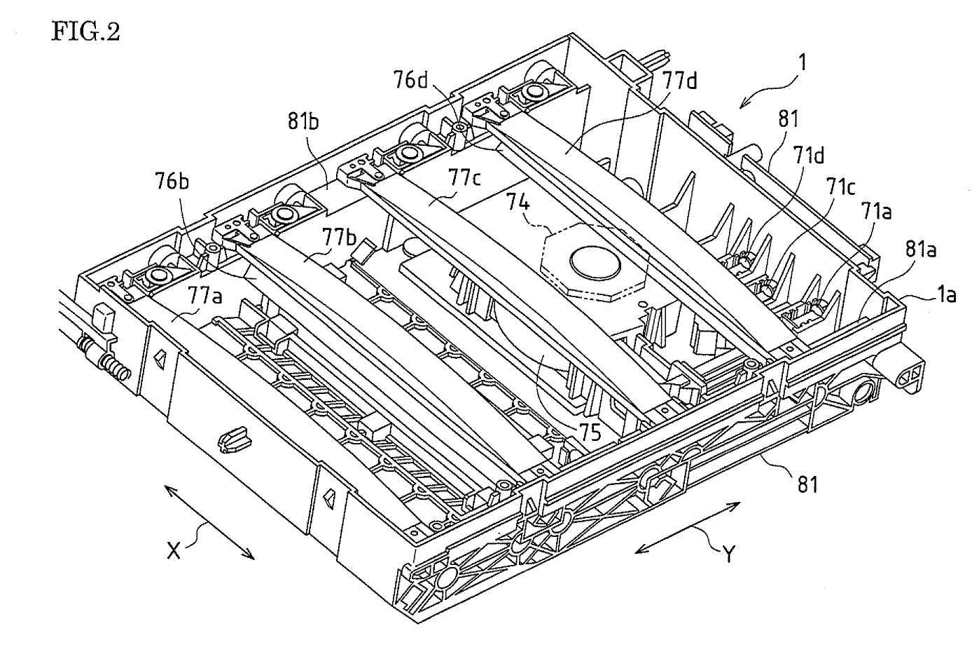

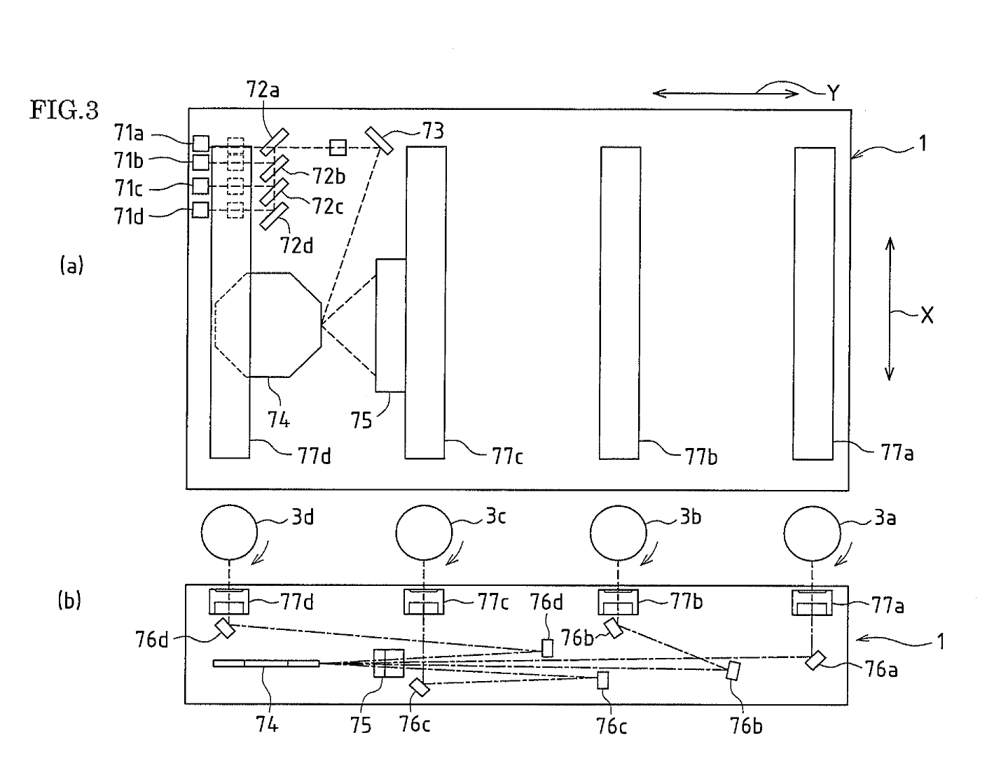

Next, detailed description is given of the optical scanning device 1 according to the present embodiment. FIG. 2, FIG. 3(a), and FIG. 3(b) are a perspective view, a top view, and a cross-sectional view showing the optical scanning device 1 according to the present embodiment.

The optical scanning device 1 according to the present embodiment is provided with laser diodes 71a, 71b, 71c, and 71d, which correspond to the colors black (K), cyan (C), magenta (M), and yellow (Y) respectively, half mirrors or mirrors 72a, 72b, 72c, and 72d, which reflect the optical beams of the laser diodes 71a, 71b, 71c, and 71d, a mirror 73 that reflects the optical beams from the half mirrors or mirrors 72a to 72d, a polygon mirror (rotating many-sided mirror) 74 the reflects each of the optical beams from the mirror 73, a first f-theta lens 75 that refracts each of the optical beams from the polygon mirror 74, a plurality of mirrors 76a, 76b, 76c, and 76d, which separately reflect each of the optical beams that has passed through the first f-theta lens 75, and four second f-theta lenses 77a, 77b, 77c, and 77d, which separately refract each of the optical beams from the mirrors 76a, 76b, 76c, and 76d respectively.

The polygon mirror 74 is a regular polygon having a columnar shape, and is driven to rotate at high speeds such that the optical beams are reflected by the mirrors of its peripheral surfaces and repetitively scan in a main scanning direction X. In order to reflect or refract the optical beams that repetitively scan in the main scanning direction X, the first f-theta lens 75, the mirrors 76, and the second f-theta lenses 77 are formed in rod shapes, which are set long in the main scanning direction X and short in a direction orthogonal to the main scanning direction X, with their respective ends being supported.

The optical beam irradiated from the laser diode 71a corresponding to black penetrates the mirror 72a, is reflected by the mirror 73, then reflected by polygon mirror 74 to scan in the main scanning direction X, then further penetrates the first f-theta lens 75, is reflected by the mirror 76a, then penetrates the second f-theta lens 77a to be incident on the photosensitive drum 3 corresponding to black. The optical beam irradiated from the laser diode 71b corresponding to cyan is reflected in order by the mirrors 72b and 72a, and the mirror 73, then reflected by polygon mirror 74 to scan in the main scanning direction X, then further penetrates the first f-theta lens 75, is reflected by the two mirrors 76b, then penetrates the second f-theta lens 77b to be incident on the photosensitive drum 3 corresponding to cyan. The optical beam irradiated from the laser diode 71c corresponding to magenta is reflected by the mirror 72c, penetrates an upper portion of the mirror 72b, and is reflected in order by the mirror 72a and the mirror 73, then reflected by polygon mirror 74 to scan in the main scanning direction X, then further penetrates the first f-theta lens 75, is reflected by the two mirrors 76c, then penetrates the second f-theta lens 77c to be incident on the photosensitive drum 3 corresponding to magenta. The optical beam irradiated from the laser diode 71d corresponding to yellow is reflected by the mirror 72d, penetrates upper portions of the mirrors 72c and 72b in order, and is reflected in order by the mirror 72a and the mirror 73, then reflected by polygon mirror 74 to scan in the main scanning direction X, then further penetrates the first f-theta lens 75, is reflected by the two mirrors 76d, then penetrates the second f-theta lens 77d to be incident on the photosensitive drum 3 corresponding to yellow.

As described earlier, the photosensitive drums 3 are rotationally driven in the arrow direction, and are irradiated by the optical beams that repetitively scan in the main scanning direction X such that an electrostatic latent image is formed on the surface of each of the photosensitive drums 3. Each of the electrostatic latent images on the photosensitive drums 3 becomes a toner image after being developed respectively, and these toner images are superimposed and transferred onto the recording paper by way of the intermediate transfer belt 7, thereby becoming a color toner image on the recording paper.

Furthermore, an upper side of a main casing 1a of the optical scanning device 1 is open only at a position of each of the second f-theta lenses 77a to 77d, and is closed at other positions so as to be light shielded (not shown in drawings), thereby preventing entrance of extraneous light.

In this regard, if there is unevenness in the optical output of the laser diodes 71a to 71d in the optical scanning device 1, this becomes unevenness in the electrostatic latent images on the surfaces of the photosensitive drums 3, which as a result produces unevenness in the print density of the color toner image.

For this reason, in the present embodiment, the optical output level of the laser diodes is detected by a photodiode for each of the laser diodes, and this photodiode detection output is used in feedback control of the laser diodes, thereby achieving stabilization of the optical output levels of the laser diodes.

Furthermore, in the conventional circuit shown in FIG. 10, feedback control gain is adjusted by the sensitivity adjustment volume 208 and the laser diode 201 bias is adjusted by the bias adjustment volume 209, but with this configuration, it is necessary to carry out adjustments of the optical scanning device using specialized tools in a cleanroom, such that replacing the device is the only countermeasure available when the optical scanning device malfunctions.

Accordingly, in the present embodiment, the feedback control gain and laser diode bias are stored in an EEPROM (nonvolatile memory), and the feedback control is carried out according to arithmetic processing by an integrated circuit using the gain and bias in the EEPROM such that malfunctions of the optical scanning device can be addressed by rewriting the gain and bias in the EEPROM.

Next, description is given of a configuration of an integrated circuit and EEPROM in the optical scanning device 1 according to the present embodiment.

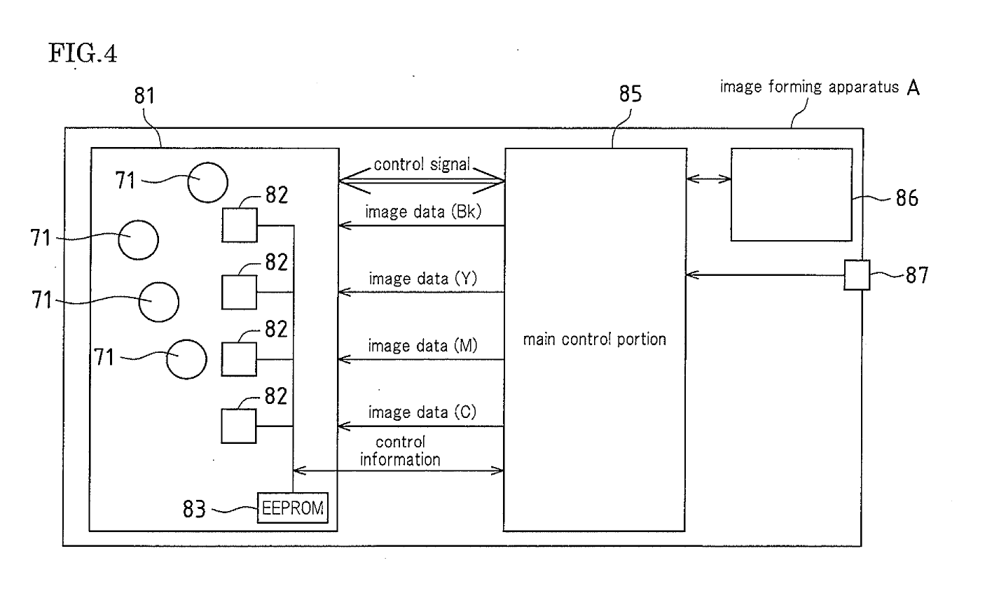

FIG. 4 is a block diagram showing components such as the laser diodes 71a to 71d, the integrated circuits, and the EEPROM mounted on a substrate in the optical scanning device 1, and components such as a main control portion and an operation panel in the image forming apparatus A. It should be noted that hereinafter the reference symbols 71a to 71d for each of the laser diodes are unified to a reference symbol 71.

In FIG. 4, a substrate 81 of the optical scanning device 1 is secured to a rear surface side of the main casing 1a (shown in FIG. 2) of the optical scanning device 1, and mounted on this substrate 81 are four laser diodes 71, integrated circuits 82 for controlling the laser diodes 71 respectively, and an EEPROM 83.

Each of the integrated circuits 82 on the substrate 81 receives control signals and image data corresponding to the colors black (K), cyan (C), magenta (M), and yellow (Y) from a main control portion 85 of the image forming apparatus A, and sets a main scanning period or the like for the optical beam of each of the laser diodes 71 based on the control signal, and turns each of the laser diodes 71 on and off in response to the image data of the colors.

Furthermore, from the main control portion 85, the EEPROM 83 on the substrate 81 receives control information that has been inputted by operation of all operation panel 86 of the image forming apparatus A or receives control information that has been inputted from an external terminal (not shown in drawings) such as a personal computer via a LAN terminal 87 of the image forming apparatus A, then stores this control information. In this way, the control information in the EEPROM 83 can be rewritten. Specifically, control information in the EEPROM 83 from the image forming apparatus 100 or an external terminal can be rewritten by applying I2C or Microwire or the like, which are commonly known transmission formats to memories.

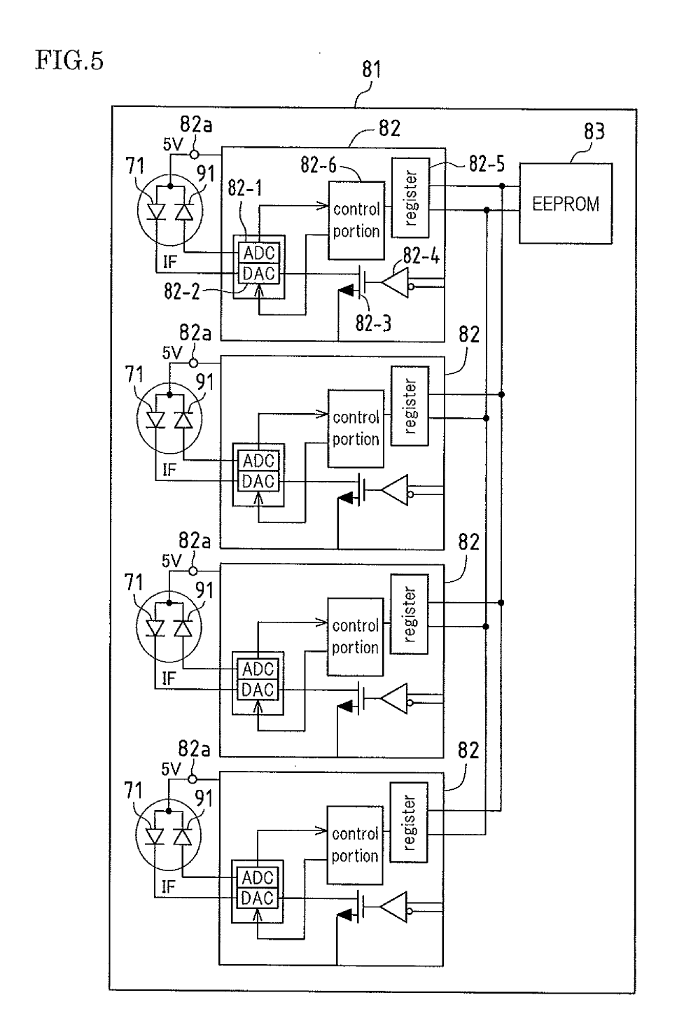

FIG. 5 is a block diagram showing an overall circuit configuration on the substrate 81 of the optical scanning device 1. In FIG. 5, a photodiode 91 is provided in a row for each of the laser diodes 71 respectively to detect the optical output level of the relevant laser diode 71. In each of the combinations of the laser diodes 71 and the photodiodes 91, the anode of the laser diode 71 and the cathode of the photodiode 91 are commonly connected to a power terminal 82a of the integrated circuit 82, and a voltage of 5V is applied to the laser diodes 71 in a forward direction and a voltage of 5V is applied to the photodiodes 91 in a reverse direction. Furthermore, the anodes of the photodiodes 91 are each connected to an AD converter 82-1 of the integrated circuit 82, and the cathodes of the laser diodes 71 are each connected to a DA converter 82-2 of the integrated circuit 82.

In the integrated circuit 82, a switching element 82-3 is inserted between an analog output side of the DA converter 82-2 and the ground. Image data from the main control portion 85 of the image forming apparatus A is applied via a receiver 82-4 to the gate of the switching element 82-3, and the switching element 82-3 switches on/off in response to the binary image data.

The EEPROM 83 receives and stores control information from the main control portion 85 of the image forming apparatus A. A portion of the control information stored in the EEPROM 83 is loaded and stored in a register 82-5 of each of the integrated circuits 82.

The control information in the register 82-5 of each of the integrated circuits 82 includes feedback control gain and laser diode bias current values that are set for each combination of the laser diodes 71 and the photodiodes 91.

A control portion 82-6 of each of the integrated circuits 82 performs drive control of the laser diodes 71 based on the control information in its respective register 82-5.

Furthermore, the control information includes a variation pattern of optical beam intensities (light amount correction data) for a single main scan period of the photoreceptor surface by the optical beam of the laser diode 71. Specifically, the variation pattern is a ratio of optical beam intensities for setting the density of each pixel in the single main scan line, and is repeated for each single main scan period.

Further still, the control information includes information such as a model number and lot number of the laser diode 71, information of the substrate 81, a ROM area of the integrated circuit 82, information of the EEPROM 83, and an ID.

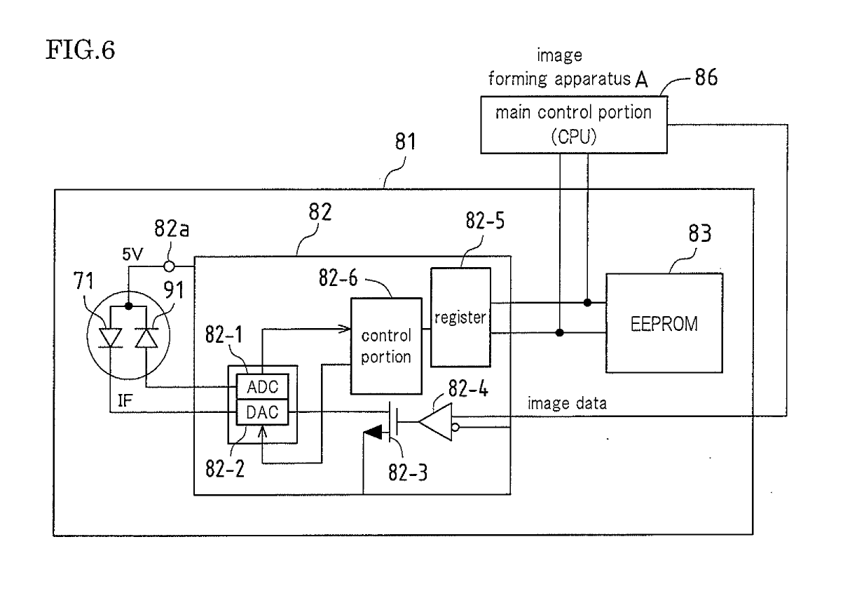

FIG. 6 is a block diagram showing a select view of one combination of the laser diode 71 and the photodiode 91, the integrated circuit 82, the EEPROM 83, and the main control portion 85 of the image forming apparatus A. Detailed description is given of control of the laser diodes 71 with reference to FIG. 6.

The photodiode 91 detects the optical output level of the laser diode 71 when the laser diode 71 emits light, and outputs a detection output corresponding to this optical output level to the AD converter 82-1. The AD converter 82-1 performs analog-digital conversion on the detection output of the photodiode 91 and outputs a value of the converted detection output (which corresponds to the optical output level of the laser diode 71) to the control portion 82-6.

Upon receiving this value of the converted detection output, the control portion 82-6 obtains a value that indicates a drive current IF of the laser diode 71 such that this value becomes a target prescribed value, then outputs this value indicating the drive current IF to the DA converter 82-2.

The DA converter 82-2 performs digital-analog conversion on the value indicating the drive current IF, then sets the drive current IF to be provided via this DA converter 82-2.

A binary signal of image data is applied through the receiver 82-4 to the switching element 82-3, which switches on/off in response to the binary signal of image data. In this way, a drive current IF route, which is constituted by the laser diode 71, to the DA converter 82-2, then to the switching element 82-3, is turned on and off. When this route is on, the drive current IF is provided through the DA converter 82-2, and the optical output level of the laser diode 71 becomes corresponding to the prescribed value that is targeted. Furthermore, the laser diode 71 is turned on and off in response to the binary signal of image data.

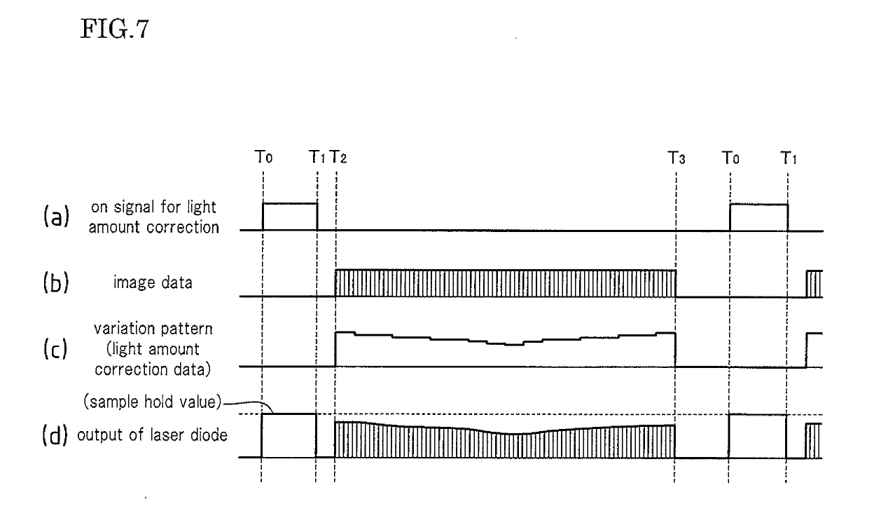

FIG. 7 (FIGS. 7(a) to 7(d)) shows timing charts indicating operations in the circuit shown in FIG. 6. In FIG. 7, a period from T₂ to T₃ is a single main scanning period. A period from T₀ to T₁ is set prior to this main scanning period, and as shown in FIG. 7(a), a light power correction on signal is applied to the switching element 82-3 via the receiver 82-4 in this T₀ to T₁ period such that the switching element 82-3 turns on and the drive current IF is provided to the laser diode 71, then the laser diode 71 emits light, and the detection output of the photodiode 91 undergoes analog-digital conversion by the AD converter 82-1, then this converted detection output value (which corresponds to the optical output level of the laser diode 71) is applied to the control portion 82-6. Upon receiving this value of the converted detection output, the control portion 82-6 obtains a value that indicates a drive current IF of the laser diode 71 such that this value converges on a target value (a prescribed value that is targeted), then outputs this value indicating the drive current IF to the DA converter 82-2. The DA converter 82-2 performs digital-analog conversion on the value indicating the drive current IF, then sets the drive current IF to be provided via this DA converter 82-2. In this way, the output level of the laser diode 71 undergoes feedback control.

A sample hold value in the period T₀ to T₁ as shown in FIG. 7(d), which is obtained by performing analog-digital conversion on the detection output of the photodiode 91 has undergone, is stored in the register 82-5.

Following this, in the main scan period of T₂ to T₃, the control portion 82-6 references the variation pattern (shown in FIG. 7(c)) of optical beam intensities in the main scan period in the register 82-5 to obtain from this variation pattern a ratio of optical beam intensities for each pixel in the main scan line, then multiples this ratio by the sample hold value in the register 82-5, then sets this product as the prescribed value to be targeted, and a value indicating the drive current IF of the laser diode 71 is obtained such that the value indicating the detection output of the photodiode 91 becomes the prescribed value. In this way, accompanying the scanning of each pixel in the main scanning line by the optical beam of the laser diode 71, a value of the drive current IF is successively obtained so that the output level of the laser diode 71 changes with that variation pattern. The DA converter 82-2 receives the value of the drive current IF for each pixel in the main scanning period, performs digital-analog conversion on this value, and sets the drive current IF of this value. Then, the switching element 82-3 switches on/off in response to the binary signal of image data as shown in FIG. 7(b), thereby turning the laser diode 71 on and off. In this way, in the main scanning period of T₂ to T₃ shown in FIG. 7(d), the output level of the laser diode 71 changes with the variation pattern in the main scanning period in the register 82-5.

The variation pattern of output levels of the laser diode 71 in the main scanning period shown in FIG. 7(c) is for shading correction. In this way, limb darkening and the like of the optical system is corrected.

These operations of T₀ to T₃ are repeated for each main scan so that writing is carried out by the optical beam of the laser diode 71.

Furthermore, the control portion 82-6 obtains feedback control gain contained in the control information in the register 82-5 and uses the gain to obtain a value of the drive current IF when obtaining a value indicating the drive current IF of the laser diode 71 so that the value indicating the detection value of the photodiode 91 becomes the prescribed value as described earlier. That is, in the arithmetic expression for obtaining the value of the drive current IF, the drive current IF is obtained by substituting the value of the optical output level, the targeted prescribed value of the value indicating the detection output of the photodiode 91, and the gain. In this way, even if there is great unevenness in the characteristics of each laser diode, the laser diodes can be controlled in a stable manner. It should be noted that this arithmetic expression may be an ordinary expression used in laser diode feedback control.

Further still, the control portion 82-6 obtains a bias current value of the laser diode contained in the control information in the register 82-5, and outputs this bias current value to the DA converter 82-2.

The DA converter 82-2 performs digital-analog conversion on the bias current value and sets a bias current of this value, then this bias current is provided to the DA converter 82-2 from the laser diode 71. When the switching element 82-3 is on, a drive current IF larger than the bias current is provided to the laser diode 71, and therefore the bias current is provided when the switching element 82-3 is off. Due to this increase/decrease of the bias current, the response characteristics of the laser diode 71 can be adjusted.

Thus, in the optical scanning device 1 according to the present embodiment, the integrated circuit 82 performs analog-digital conversion on the detection output of the photodiode 91, then uses this converted detection output value (a value of the optical output level of the laser diode 71), the prescribed value in the EEPROM 83, and the feedback control gain to calculate and obtain a value indicating the drive current IF of the laser diode 71, then performs digital-analog conversion on the obtained valued indicating the drive current IF and provides a drive current IF of this converted value to the laser diode 71. For this reason, the feedback control of the laser diode 71 can always be carried out accurately.

Furthermore, the bias current value of the laser diode 71 is stored in the EEPROM 83, and the bias current value of the laser diode 71 is read out from the EEPROM 83 and set by the integrated circuit 82, and therefore the response characteristics of the laser diode 71 can be controlled.

Further still, a variation pattern of optical beam intensities in a single main scanning period by the optical beam of the laser diode 71 is stored in the EEPROM 83, and the drive current IF of the laser diode 71 is controlled by the integrated circuit 82 so that the variation pattern of optical beam intensities is reproduced in the single main scanning period, and therefore shading correction can be carried out.

Furthermore, the integrated circuits 82 and the EEPROM 83 are mounted on a common substrate 81, and therefore a correspondence of the integrated circuit 82 can be maintained with the control information indicating the feedback control gain and the like in the EEPROM 83.

Further still, since the EEPROM 83 is used mounted separately without using an inbuilt memory of the integrated circuit 82, control information that has been inputted by operation of the operation panel 86 of the image forming apparatus A or control information that has been inputted from an external terminal (not shown in drawings) such as a personal computer via the LAN terminal 87 of the image forming apparatus A can be stored in the EEPROM 83, and it is possible to rewrite the feedback control gain and bias current values of the laser diode 71 in the EEPROM 83. Adjustment and repair of the optical scanning device 1 are possible by rewriting the gain and bias current values, thereby reducing the frequency of replacing malfunctioned optical scanning devices as conventionally, and maintenance qualities are improved.

Supposing a case where feedback control gain and bias current values are stored in an inbuilt memory of the integrated circuit 82, then external access to the memory of the integrated circuit 82 is difficult and maintenance qualities cannot be improved.

On the other hand, information such as a model number and lot number of the laser diode 71, information of the substrate 81, a ROM area of the integrated circuit 82, information of the EEPROM 83, and an ID are stored in the EEPROM 83, and access to the EEPROM 83 can be achieved from the image forming apparatus A or an external terminal as described earlier, and therefore the maintenance qualities of the optical scanning device 1 are improved. For example, by reading out the model numbers and lot numbers of the laser diodes 71 from the EEPROM 83, it is possible to understand characteristics of the laser diodes based the model numbers and lot numbers, and by reading out information and ID of the substrate 81 from the EEPROM 83, it is possible to manage the optical scanning device 1 based on the information and ID or the like of the substrate 81.

Further still, if maintenance history information is written into the EEPROM 83 by access from the image forming apparatus A or an external terminal, then when the optical scanning device 1 malfunctions, it is easier to investigate causes and the like of the malfunction based on this history information.

By providing the EEPROM 83 separate from the integrated circuit 82, the maintenance qualities of the optical scanning device 1 can be improved dramatically.

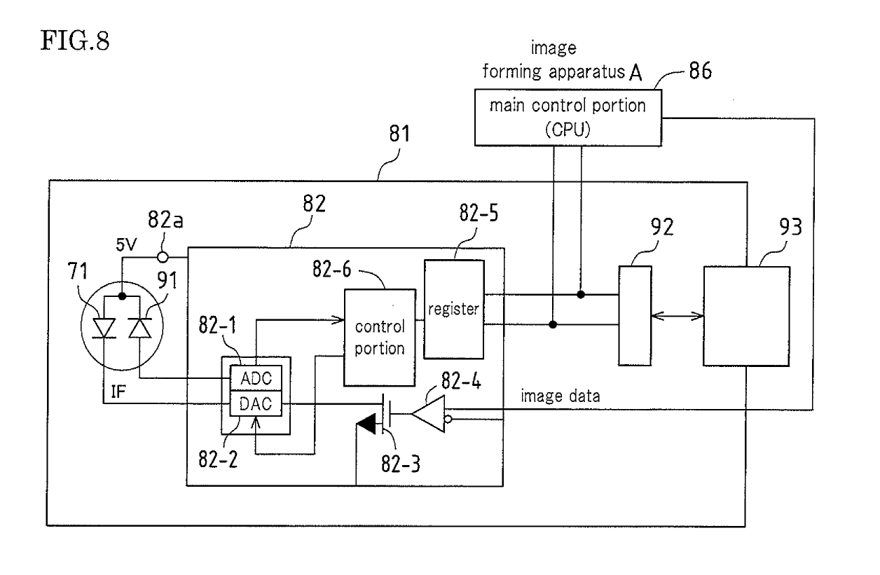

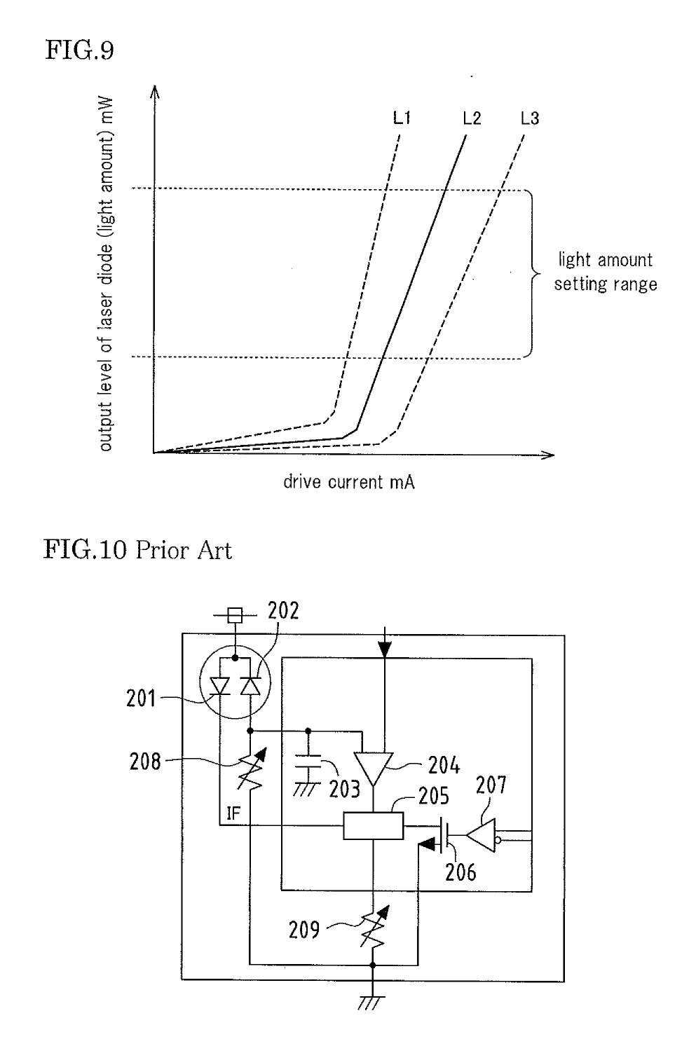

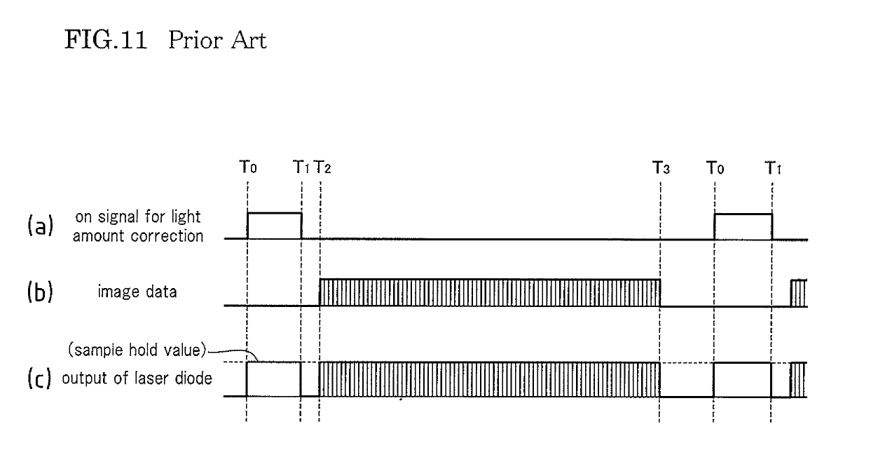

It should be noted that a nonvolatile memory that is removable from the substrate 81 may be applied instead of the EEPROM 83. Specifically, as shown in FIG. 8, a USB memory connection terminal or a memory card slot 92 is installed on the substrate 81, and a USB memory or a memory card 93 connects in a readily detachably manner to the connection terminal or the slot 92, then control information in the USB memory or memory card 93 is taken into the control portion 82-6 of the integrated circuit 82. Furthermore, the USB memory or memory card 93 is removed and connected to a personal computer or the like, and the control information in the USB memory or memory card 93 is rewritten.

The foregoing described preferable embodiments and working examples of the present invention with reference to the accompanying drawings, but the present invention is not limited to these examples. It is evident that a person skilled in the art would be capable of conceiving various modifications and alterations within the scope described by the claims, and naturally all of these are to be interpreted as belonging to the technical scope of the present invention.

What is claimed is:

1. An optical scanning device, comprising a semiconductor laser that outputs an optical beam, and a light-receiving element that detects an optical output level of the semiconductor laser, wherein detection output of the light-receiving element is used in feedback control of a drive current of the semiconductor laser, and a photoreceptor surface of an image forming apparatus is scanned by the optical beam of the semiconductor laser,
further comprising:
a nonvolatile memory in which gain of the feedback control is stored,
an integrated circuit that calculates and obtains a drive current of the semiconductor laser based on the detection output of the light-receiving element and the feedback control gain in the nonvolatile memory, and provides the obtained drive current to the semiconductor laser, and
a substrate on which the integrated circuit and the nonvolatile memory are mounted together.

2. The optical scanning device according to claim 1,
wherein the nonvolatile memory stores a bias current value of the semiconductor laser, and
the integrated circuit reads out the bias current value of the semiconductor laser from the nonvolatile memory and provides a bias current of this value to the semiconductor laser.

3. The optical scanning device according to claim 1,
wherein the nonvolatile memory stores a variation pattern of optical beam intensities in a single scan period of the photoreceptor surface by the optical beam of the semiconductor laser, and
the integrated circuit reads out from the nonvolatile memory the variation pattern of optical beam intensities in a single scan period of the photoreceptor surface and controls a drive current of the semiconductor laser so that the variation pattern that has been read out is reproduced in each single scan of the photoreceptor surface.

4. The optical scanning device according to claim 1,
wherein the nonvolatile memory carries out reading and writing according to access from an image forming apparatus or an external terminal.

5. The optical scanning device according to claim 1,
wherein the nonvolatile memory is removable from the substrate.

6. The optical scanning device according to claim 1,
wherein the nonvolatile memory stores information relating to the optical scanning device.

7. An optical scanning device, comprising a semiconductor laser that outputs an optical beam, wherein a photoreceptor surface of an image forming apparatus is scanned by the optical beam of the semiconductor laser,
further comprising:
a nonvolatile memory that stores information relating to the optical scanning device,
an integrated circuit that controls the semiconductor laser based on the information in the nonvolatile memory, and
a substrate on which the integrated circuit and the nonvolatile memory are mounted together,
wherein the nonvolatile memory is capable of reading and writing according to access from an external source.

8. An image forming apparatus comprising an optical scanning device according to claim 1.

9. An image forming apparatus comprising an optical scanning device according to claim 7.
